(19) United States
(12) Patent Application Publication
(10) Pub. No.: US 2009/0135455 A1
(43) Pub. Date: May 28, 2009

(54) Image processing method of removing flaw and device using the same

(75) Inventor: Li-Cao Li, Suzhou (CN)

Correspondence Address: BACON & THOMAS, PLLC, 625 SLATERS LANE, FOURTH FLOOR, ALEXANDRIA, VA, 22314-1176, US

(73) Assignee: Qisda Corporation, Taoyuan Shien (TW)

(21) Appl. No.: 12/285,637

(22) Filed: Oct. 10, 2008

(30) Foreign Application Priority Data
Nov. 26, 2007 (TW) 96144844

(51) Int. Cl. G06K 9/40; G06K 9/00; H04N 1/04

(52) U.S. Cl. 358/487; 382/275; 382/167

(57) ABSTRACT

An image processing method of removing flaw and a device using the same are provided. The image processing method is used in an image processing device and includes the following steps. Firstly, a transparent manuscript is transparently scanned to obtain a first scanning image. Next, the transparent manuscript is reflectively scanned to obtain a second scanning image. Then, a flaw-positioning image is obtained via the second scanning image. Afterwards, the first scanning image is modified by using the flaw-positioning image according to an image-recovered method for correcting the image value of the pixel in the first scanning image corresponding to at least part of the flaw in the transparent manuscript.

This application claims the benefit of Taiwan application Serial No. 96144844, filed Nov. 26, 2007, the subject matter of which is incorporated herein by reference.

### BACKGROUND OF THE INVENTION

1. Field of the Invention

The invention relates in general to an image processing method and the device using the same, and more particularly to an image processing method of removing flaw and the device using the same.

2. Description of the Related Art

With the popularity of information digitalization, nowadays most of the images, films and photos are stored in digital formats. Meanwhile, the scanner further converts the images, films and photos from non-digital format into digital format. If information is stored in a non-digital format, then scratch, dust or shear marks may easily occur especially on the films. The most popular technology used in a scanner for removing film scratch is infrared scratch removing technology. The method recognizes the position of dust or scratch by projecting an infrared light onto the dyes on the film, and repairs the scanning image by image software to remove scratches and shear marks.

Referring to FIG. 1, a perspective of a conventional scanner capable of removing scratching is shown. The scanner 10 includes a lamp 11, a diffusion plate 12, a lens 14 and a charge coupled device (CCD) 15. The lamp 11 is disposed above the diffusion plate 12 for emitting a light 13, wherein the light 13 includes visible lights and an infrared light. The light 13 emitted from the lamp 11 is diffused via the diffusion plate 12 and uniformly passes through the film 20. After the light 13 passes through the film 20, the light 13 is imaged on the CCD 15 via the lens 14.

Referring to FIG. 2, a perspective of the CCD of FIG. 1 is shown. The CCD 15 includes four sensors of four different channels, namely, a red-light sensor 15a, a green-light sensor 15b, a blue-light sensor 15c and an infrared sensor 15d. The four sensors are for receiving a red light, a green light, a blue light and an infrared light. The red-light sensor 15a, the green-light sensor 15b, and the blue-light sensor 15c form an scanning image according to the received information, and the infrared sensor 15d detects the position of the scratch on the film. Lastly, the image is recovered by computer image software according to the scanning image and the information of scratch positions such that scratches and shear marks are removed.

However, the scanner 10 with scratch removing function must be equipped with a lamp 11 capable of emitting visible lights and an infrared light at the same time. When the lamp 11 is implemented by a cold cathode fluorescent lamp, the fluorescent powder has three primal colors, and the wavelength of the emitted light is within the wavelength of visible lights. However, to provide an infrared with sufficient intensity, an addition fluorescent powder for emitting infrared light must be added. When the lamp 11 is implemented by a light emitting diode (LED), an additional LED for emitting an infrared light must be added. However, the above two methods result in an increase in scanner cost.

Besides, the CCD 15 needs to be equipped with an infrared sensor 15d for receiving an infrared light. If a single sensor is used, the rotation color filter disposed at the back of the light source needs to be equipped with an infrared color filter. Thus, no matter which conventional method is used, the cost of the scanner 10 will increase. The infrared scratch removing technology has good effect but requires a special light source (infrared light) or a special sensor (color filter in the CCD), hence making product price increase. Therefore, how to provide an economic scanner capable of removing scratches and shear marks from film image has become an imminent issue to be resolved.

### SUMMARY OF THE INVENTION

The invention is directed to an image processing method of removing flaw and a device using the same. The image processing method removes the flaw without using any additional elements, hence reducing manufacturing costs.

According to a first aspect of the present invention, an image processing method is provided. The image processing method includes the following steps. Firstly, a transparent manuscript is transparently scanned to obtain a first scanning image. Next, the transparent manuscript is reflectively scanned to obtain a second scanning image. Then, a flaw-positioning image is obtained via the second scanning image. Afterwards, the first scanning image is modified by using the flaw-positioning image according to an image-modifying method for correcting the image value of the pixel in the first scanning image corresponding to at least part of the flaw in the transparent manuscript.

According to a second aspect of the present invention, an image processing device is provided. The image processing device is used in a transparent manuscript and includes a transparent scanning light source, a reflective scanning light source, a scanning module and an image processing module. The transparent scanning light source is for generating a first light. The reflective scanning light source is for generating a second light. The scanning module is for receiving the first light which has passed through the transparent manuscript to obtain a first scanning image, and receiving the second light reflected from the transparent manuscript to obtain a second scanning image. The image processing module obtains a flaw-positioning image via the second scanning image. The image processing module modifies the first scanning image by using the flaw-positioning image according to an image-recovered method for correcting the image value of the pixel in the first scanning image corresponding to at least part of the flaw in the transparent manuscript.

The invention will become apparent from the following detailed description of the preferred but non-limiting embodiments. The following description is made with reference to the accompanying drawings.

### BRIEF DESCRIPTION OF THE DRAWINGS

FIG. 1 (Prior Art) shows a perspective of a conventional scanner capable of removing scratching;

FIG. 2 (Prior Art) shows a perspective of the CCD of FIG. 1;

FIG. 3 shows a perspective of an image processing device according to a first embodiment of the invention;

FIG. 4 shows a flowchart of an image processing method according to a first embodiment of the invention;

FIG. 5 shows a part of detailed block diagram of an image processing device according to a first embodiment of the invention;

FIG. 6 shows an example of an image in the transparent manuscript of FIG. 3;

FIG. 7 shows a perspective of a first scanning image I1 in the transparent manuscript of FIG. 6;

FIG. 8 shows a perspective of a second scanning image I2 corresponding to the transparent manuscript of FIG. 6;

FIG. 9 shows a perspective of a flaw-positioning image I3 obtained according to the second scanning image I2 of FIG. 8;

FIG. 10 shows a perspective of an modified image I5 obtained according to according to the first scanning image I1 of FIG. 9; and

FIG. 11 shows a part of detailed block diagram of an image processing device according to a second embodiment of the invention.

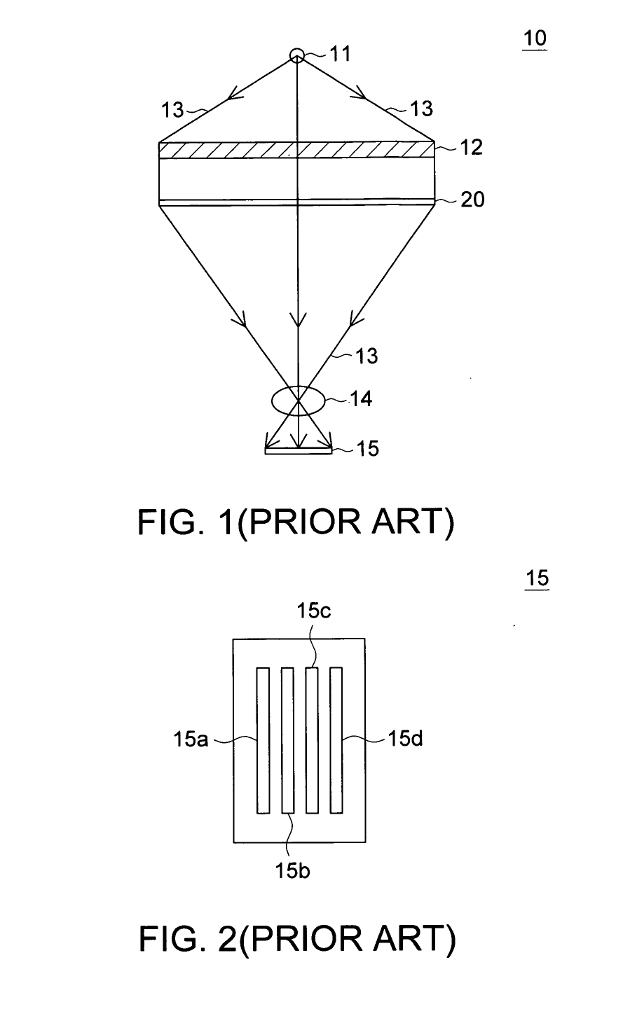

### DETAILED DESCRIPTION OF THE INVENTION

A first embodiment and a second embodiment are disclosed below for elaborating the invention. However, the procedures and drawings disclosed in these embodiments are for elaboration only not for limiting the scope of protection of the invention. Moreover, secondary elements are omitted for highlighting the technical features of the invention.

### First Embodiment

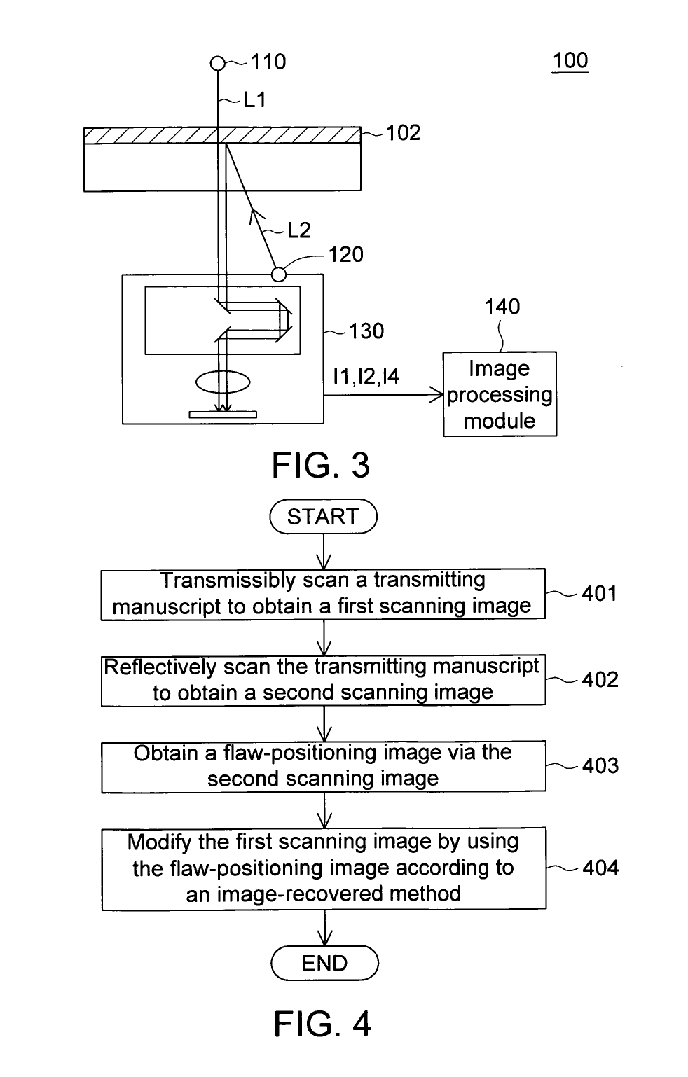

Referring to FIG. 3, a perspective of an image processing device according to a first embodiment of the invention is shown. The image processing device 100 is used in a transparent manuscript 102. The image processing device 100 includes a transparent scanning light source 110, a reflective scanning light source 120, a scanning module 130 and an image processing module 140. The transparent scanning light source 110 is for generating a first light L1. The reflective scanning light source 120 is for generating a second light L2. The scanning module 130 is for receiving the first light L1, which has passed through the transparent manuscript 102, to obtain a first scanning image I1 and receiving the second light L2 reflected from the transparent manuscript 102 to obtain a second scanning image I2. The image processing module 140 obtains a flaw-positioning image 13 via the second scanning image I2. The image processing module 140 modifies the first scanning image I1 by using the flaw-positioning image I3 according to an image-recovered method for correcting the image value of the pixel in the first scanning image I1 corresponding to at least part of the flaw in the transparent manuscript 102. The transparent scanning light source 110 and the reflective scanning light source 120 can be obtained from the same light source via the conversion of optical path.

Referring to FIG. 4, a flowchart of an image processing method according to a first embodiment of the invention is shown. In the present embodiment of the invention, the image processing device 100 is exemplified as a scanner having transparently scanning functions. The details of the image processing method are disclosed with the flowchart of FIG. 4.

Referring to FIG. 3 and FIG. 4. Firstly, the method begins at step 401, a transparent manuscript 102 is reflectively scanned to obtain a first scanning image I1. The image processing device 100 sends a first light L1 from The transparent scanning light source 110, wherein the first light L1 passes through the transparent manuscript 102, and the scanning module 130 receives the first light L1, which has passed through the transparent manuscript 102, to obtain a first scanning image I1.

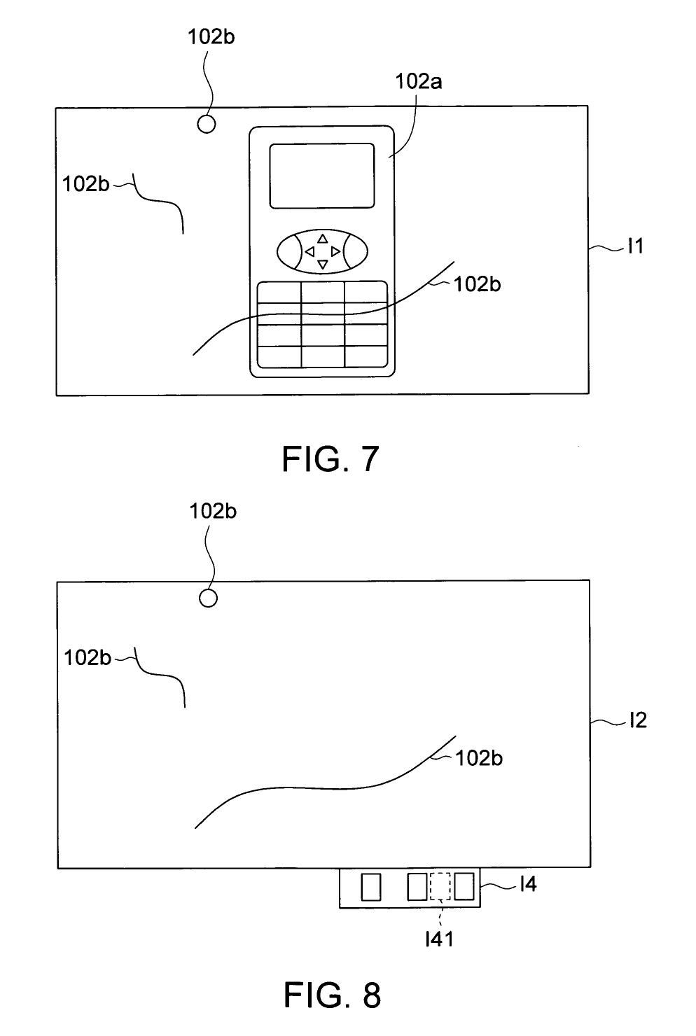

The flowchart of FIG. 4 is disclosed in an example below. Referring to FIG. 6 and FIG. 7. FIG. 6 s shows an example of an image in the transparent manuscript of FIG. 3. FIG. 7 shows a perspective of a first scanning image I1 in the transparent manuscript of FIG. 6. In the present embodiment of the invention, the transparent manuscript 102 is exemplified as a film having an image record region 102r and a marginal region 102c, wherein the image record region 102r has image information 102a and a plurality of flaws 102b. Examples of the flaws 102b include scratches, dust and shear marks. On the part of the transparent manuscript 102, only the image record region 102r has image information 102a, but the marginal region 102c does not have. In step 401, the image processing device 100 merely scans the image record region 102r to obtain the first scanning image I1 as indicated in FIG. 7. Besides, the image record region 102r has image information 102a and a plurality of flaws 102b, so the first scanning image I1 also has image information 102a and a plurality of flaws 102b.

Next, the method proceeds to step 402, the transparent manuscript 102 is reflectively scanned by a reflective scanning light source 120 to obtain a second scanning image I2. Also, referring to FIG. 8, a perspective of a second scanning image I2 corresponding to the transparent manuscript of FIG. 6 is shown. In the present step, the image processing device 100 turns off the transparent scanning light source 110 but turns on the reflective scanning light source 120 so that the reflective scanning light source 120 sends a second light L2, the second light L2 is then reflected by the transparent manuscript 102, and the scanning module 130 receives the second light L2 reflected to the transparent manuscript 102 to obtain the second scanning image I2.

As indicated in FIG. 8, the reflective scanning light source 120 scans the image record region 102r of the transparent manuscript 102 to obtain the second scanning image I2, and concurrently scans a marginal region 102c of the transparent manuscript 102 to obtain a marginal region image I4 corresponding to the marginal region 102c. Normally, on the part of the transparent manuscript 102, the marginal region 102c having not recorded any image has the maximum reflection ratio, and the reflection ratio in the image record region 102r is equal to or smaller than that in the marginal region 102c because the image record region 102r already wears dyes. As the condition of reflection of the image record region 102r change due to the existence of the flaws 102b in the transparent manuscript 102, the reflection ratio of the flaws 102b is larger than that in the marginal region 102c. Thus, each image value of the pixel recorded in FIG. 8 responds to the reflection ratio of each pixel in the transparent manuscript 102. Whenever the transparent manuscript 102 scans with the reflective scanning light source 120, the image information 102a will not be shown in the second scanning image I2, and only the image corresponding to the flaw 102b will be shown in the second scanning image I2.

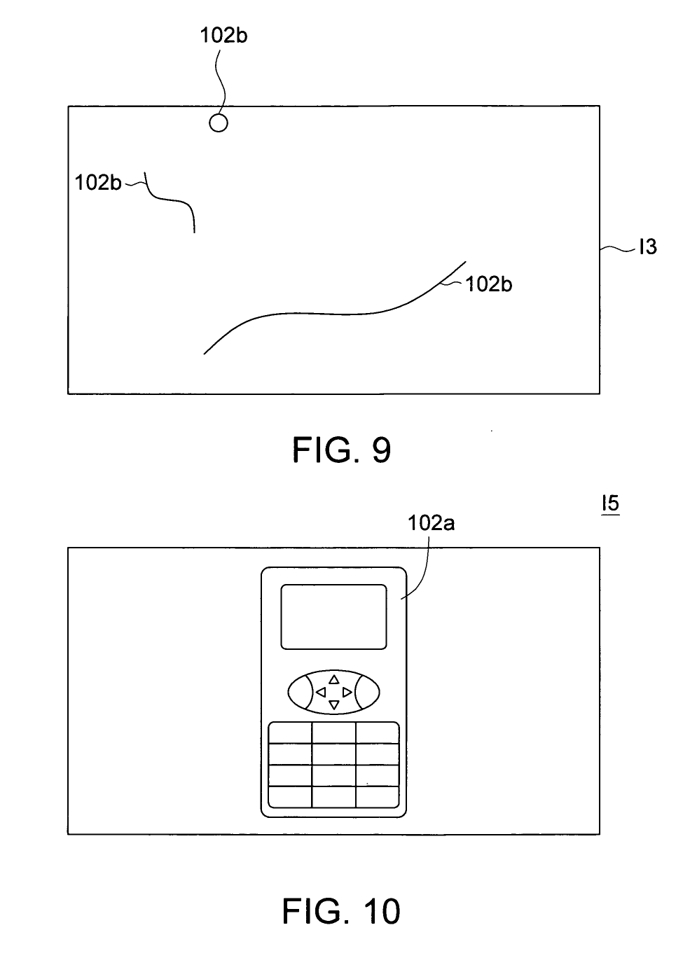

Next, the method proceeds to step 403, the image processing module 140 obtains a flaw-positioning image I3 via the second scanning image I2. Also, referring to FIG. 9, a perspective of a flaw-positioning image I3 obtained according to the second scanning image I2 of FIG. 8 is shown. To obtain the flaw-positioning image I3, an image value of each pixel in the second scanning image I2 is compared with a threshold value to determine whether the image value of each pixel is larger than threshold value. If yes, the image value of the pixel corresponding to the flaw-positioning image I3 is set as a first color, otherwise, the image value of the pixel corresponding to the flaw-positioning image I3 is set as a second color. Thus, each flaw 102b is shown in the first color in the flaw-positioning image I3.

In the present embodiment of the invention, the threshold value is obtained via the marginal region image I4 for example, and a threshold value generating region image I41 is selected from the marginal region image I4 (as indicated in FIG. 8). As indicated in FIG. 6, the marginal region 102c has a plurality of through holes 102d, and a threshold value generating region 102e corresponding to the threshold value generating region image I41 is located between two neighboring through holes 102d. The image processing module 140 generates the abovementioned threshold value according to the image value of the threshold value generating region image I41. For example, an average value of a plurality of image values of a plurality of pixels in the threshold value generating region image I41 is used as the threshold value.

As disclosed above, the marginal region 102c of the transparent manuscript 102 does not wear dyes, so the marginal region 102c of the transparent manuscript 102 has the maximum reflection ratio. That is, the reflection ratio in the image record region 102r is smaller than the reflection ratio in the marginal region 102c. As both the second scanning image I2 and the marginal region image I4 are generated by receiving the second light L2 reflected from the transparent manuscript 102, the higher the reflection ratio is, the higher the luminance of corresponding pixel is, and the higher the luminance is, the larger the image value of the corresponding pixel is. If the image value of a certain pixel in the second scanning image I2 is larger than the threshold value of the marginal region image I4, this implies that the reflection condition of the pixel must have changed and the position of the pixel is exactly the position of the flaw 102b (such as scratching or dust). This is because the physical changes occurred due to scratches, shear marks or dust will make the second light L2 have a larger amount of reflection and accordingly make the image value of the pixel corresponding to the flaw 102b larger than the threshold value.

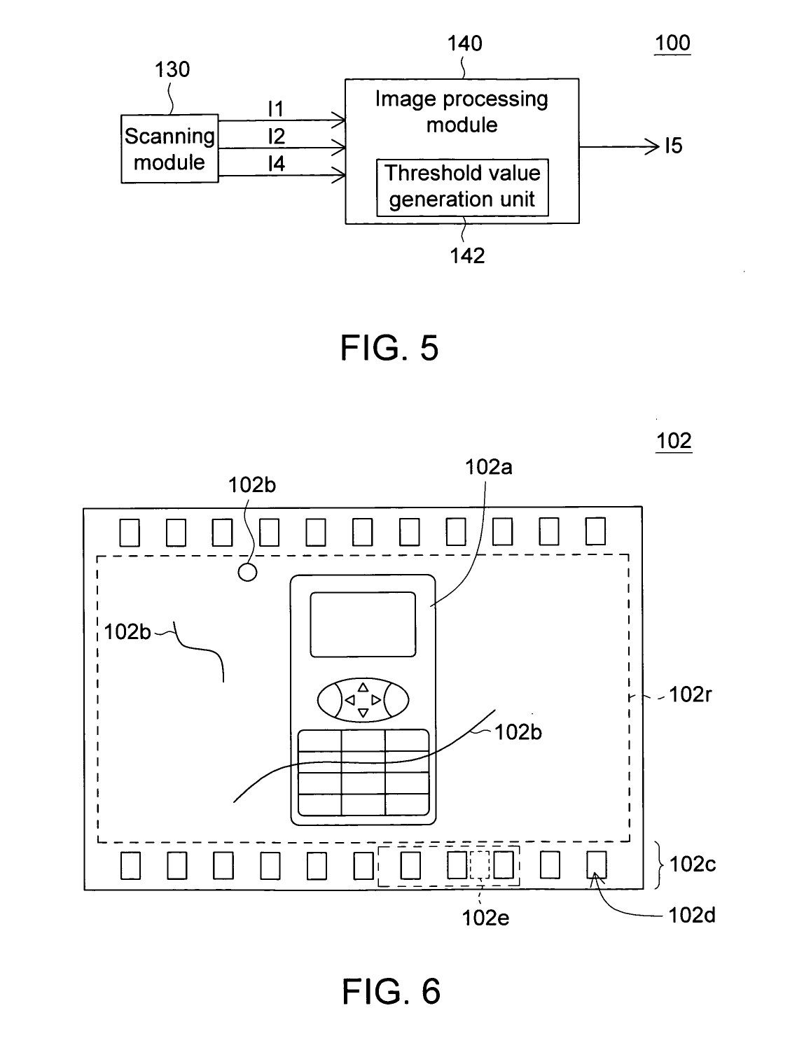

Referring to FIG. 5, a part of detailed block diagram of an image processing device according to a first embodiment of the invention is shown. The image processing module 140 preferably further includes a threshold value generation unit 142. In the present embodiment of the invention, when the image value includes the chromatic value of the RGB primal colors, after the image value of each pixel is analyzed by the image processing module 140, each image value has a red image value, a green image value and a blue image value. Meanwhile, the threshold value that the threshold value generation unit 142 of the image processing module 140 obtains from the threshold value generating region image I41 of the marginal region image I4 (as indicated in FIG. 4) preferably includes a red threshold value, a green threshold value and a blue threshold value. The present step respectively determines three conditions: (1) whether the red image value is larger than the red threshold value, (2) whether the green image value is larger than the green threshold value, (3) whether the blue image value is larger than the blue threshold value. If one of the three conditions (1)˜(3) holds true, then the image value of the pixel corresponding to the flaw-positioning image I3 is set as the first color, otherwise, the image value of the pixel corresponding to the flaw-positioning image I3 is set as the second color. To make the contrast between the first color and the second color of the flaw-positioning image I3 stronger, the first color is exemplified as white color whose chromatic value of the RGB primal colors is (255, 255, 255) and has the highest luminance of the RGB primal colors, and the second color is exemplified as black color whose chromatic value of the RGB primal colors is (0, 0, 0) and has the lowest luminance of the RGB primal colors. Thus, the image information 102a of the transparent manuscript 102 will be separated from the information of the flaws 102b (dust or scratching).

Then, the method proceeds to step 404, the image processing module 140 modifies the first scanning image I1 by using the flaw-positioning image I3 according to an image-recovered method. Referring to FIG. 10, a perspective of a modified image I5 obtained according to the first scanning image I1 of FIG. 9 is shown. The image processing module 140 obtains the position of the flaw 102b from the flaw-positioning image I3. For example, the image processing module 140 analyzes the position of the pixel having the first color in the flaw-positioning image I3 so as to obtain the position of the flaw 102b. Then, the image value of the pixel corresponding to the flaw 102b of the transparent manuscript 102 in the first scanning image I1 is corrected according to the image-recovered method. That is, the pixel having the first color in the flaw-positioning image I3 corresponding to the image value of the pixel in the first scanning image I1 is modified so to obtain a modified image I5 which contains the image information 102a only, and the flaw 102b is removed.

In the present embodiment of the invention, the image processing module 140 fits a correction value according to the image values of the pixels surrounding the pixel corresponding to the flaw 102b in the transparent manuscript 102 for correcting the image value of the pixel corresponding to the flaw 102b in the transparent manuscript 102. The correction value is an average value of the image values of the pixels surrounding the pixel corresponding to the part of the flaw 102b in the transparent manuscript 102. As the correction value for modifying the pixel of the flaw 102b in the modified image I5 is an average value of the image values of the pixels surrounding the flaw 102b, the flaw 102b will be removed by replacing the original image value of the pixel in the first scanning image I1 with the average value. The present embodiment of the invention is not limited to adopting the fitting method, and any image processing methods of removing the flaw once the position of the flaw is obtained are applicable to the present embodiment of the invention.

### Second Embodiment

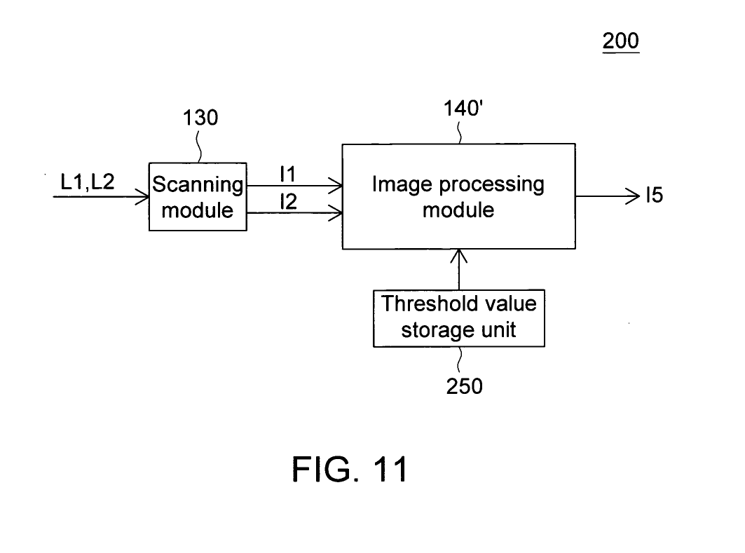

Referring to FIG. 11, a part of detailed block diagram of an image processing device according to a second embodiment of the invention is shown. The image processing method and the device using the same of the second embodiment differ with that of the first embodiment different in the method of obtaining the threshold value T, and other similarities are not repeated here.

Referring to FIG. 11, the image processing device 200 further has a threshold value storage unit 250 which records the threshold value T corresponding to different types of transparent manuscripts 102. In the present embodiment of the invention, the threshold value storage unit 250 stores the threshold value T of the transparent manuscript 102, and different types of transparent manuscripts 102 have different threshold values T.

Also, referring to FIG. 3 and FIG. 10. In step 403, the image processing module 140′ obtains a threshold value T from the threshold value storage unit 250 according to the type of the transparent manuscript 102. Next, an image value P of each pixel in the second scanning image I2 is compared with a threshold value T to determine whether each image value P is larger than the threshold value T. If yes, the image value of the pixel corresponding to the flaw-positioning image I3 is set as a first color, otherwise, the image value of the pixel corresponding to the flaw-positioning image I3 is set as a second color. Thus, the flaw 102b is shown in the first color in the flaw-positioning image I3. Thus, the image processing module 140′ modifies the first scanning image I1 according to the flaw-positioning image I3 so as to obtain a modified image I5.

Unlike the conventional scanner which requires extra elements (such as infrared light source) to remove the flaw in the image, the image processing method and the device using the same of the invention can do without using extra elements. The image processing method and the device using the same of the invention effectively reduce cost and provide the same effects that high-cost image processing device would achieve. Therefore, the image processing method and the device using the same of the invention have high performance/price ration and are competitive in the market.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An image processing method applied in an image processing device, comprising:
(a) transparently scanning a transparent manuscript to obtain a first scanning image;
(b) reflectively scanning the transparent manuscript to obtain a second scanning image;
(c) obtaining a flaw-positioning image via the second scanning image; and
(d) modifying the first scanning image by using the flaw-positioning image according to an image-recovered method for correcting the image value of the pixel in the first scanning image corresponding to at least part of the flaw in the transparent manuscript.

2. The image processing method according to claim 1, wherein the second scanning image has a plurality of pixels, the step (c) comprises:
comparing an image value of each pixel in the second scanning image with a threshold value to determine whether each image value is larger than the threshold value; if yes, the image value of the pixel corresponding to the flaw-positioning image is set as a first color, otherwise, the image value of the pixel corresponding to the flaw-positioning image is set as a second color.

3. The image processing method according to claim 2, wherein the step (d) comprises:
modifying the image value of the pixel in the first scanning image corresponding to the pixel having the first color in the flaw-positioning image.

4. The image processing method according to claim 3, wherein the image-recovered method comprises:
fitting a correction value for correcting the image value of the pixel corresponding to the part of the flaw in the transparent manuscript according to the image values of the pixels surrounding the pixel corresponding to the part of the flaw in the transparent manuscript.

5. The image processing method according to claim 4, wherein the correction value is an average value of the image values of the pixels surrounding the pixel corresponding to the part of the flaw in the transparent manuscript.

6. The image processing method according to claim 2, wherein each image value has a red image value, a green image value and a blue image value, and the threshold value has a red threshold value, a green threshold value and a blue threshold value, the step (c) comprises:
determining whether the red image value is larger than the red threshold value, whether the green image value is larger than the green threshold value, or whether the blue image value is larger than the blue threshold value; if yes, the image value of the pixel corresponding to in the flaw-positioning image is set as the first color, otherwise, the image value of the pixel corresponding to the flaw-positioning image is set as the second color.

7. The image processing method according to claim 2, wherein the transparent manuscript has a marginal region, the method further comprises:
reflectively scanning the marginal region to obtain a marginal region image corresponding to the marginal region;
selecting a threshold value generating region image from the marginal region image; and
generating the threshold value according to the image values of the pixels in the threshold value generating region image.

8. The image processing method according to claim 7, wherein the marginal region has a plurality of through holes, and a threshold value generating region corresponding to the threshold value generating region image is located between neighboring through holes.

9. The image processing method according to claim 2, wherein the image processing device has a threshold value database, which records the threshold values corresponding to different types of transparent manuscripts, the step (c) further comprises:
obtaining the threshold value from the threshold value database according to the type of the transparent manuscript.

10. An image processing device applied in a transparent manuscript, comprising:
a transparent scanning light source for generating a first light;
a reflective scanning light source for generating a second light;
a scanning module for receiving the first light which has passed through the transparent manuscript to obtain a first scanning image and receiving the second light reflected from the transparent manuscript to obtain a second scanning image; and
an image processing module to obtain a flaw-positioning image from the second scanning image, wherein the image processing module modify the first scanning image by using the flaw-positioning image according to an image-recovered method for correcting the image value of the pixel in the first scanning image corresponding to at least part of the flaw in the transparent manuscript.

11. The image processing device according to claim 10, wherein the second scanning image has a plurality of pixels, the image processing module further compares an image value of each pixel in the second scanning image with a threshold value, and the image processing module sets the image value of the pixel corresponding to the flaw-positioning image as a first color if the image value is larger than the threshold value and sets the image value of the pixel corresponding to the flaw-positioning image as a second color if the image value is smaller than the threshold value.

12. The image processing device according to claim 11, wherein the image processing module further corrects the image value of the pixel in the first scanning image corresponding to a pixel having the first color in the flaw-positioning image.

13. The image processing device according to claim 12, wherein the image processing module further fits a correction value according to the image values of the pixels surrounding the pixel corresponding to the part of the flaw in the transparent manuscript for correcting the image value of the pixel corresponding to the part of the flaw in the transparent manuscript.

14. The image processing device according to claim 13, wherein the correction value is an average value of the image values of the pixels surrounding the pixel corresponding to the part of the flaw in the transparent manuscript.

15. The image processing device according to claim 11, wherein each image value has a red image value, a green image value and a blue image value, the threshold value has a red threshold value, a green threshold value and a blue threshold value, the image processing module further determines whether the red image value is larger than the red threshold value, whether the green image value is larger than the green threshold value, or whether the blue image value is larger than the blue threshold value; if yes, the image value of the pixel corresponding to the flaw-positioning image is set as the first color, otherwise, the image value of the pixel corresponding to the flaw-positioning image is set as the second color.

16. The image processing device according to claim 11, wherein the transparent manuscript has a marginal region, the scanning module further receive the second light reflected from the marginal region to obtain a marginal region image corresponding to the marginal region.

17. The image processing device according to claim 16, wherein the image processing module further selects a threshold value generating region image from the marginal region image, and generates the threshold value according to the image values of the pixels in the threshold value generating region image.

18. The image processing device according to claim 17, wherein the marginal region has a plurality of through holes, and the threshold value generating region is located between neighboring through holes.

19. The image processing device according to claim 11, wherein the image processing device has a threshold value storage unit which records the threshold value of the threshold value storage unit corresponding to different types of transparent manuscripts.

20. The image processing device according to claim 19, wherein the image processing module obtains the threshold value from the threshold value storage unit according to the type of the transparent manuscript.
